(19) United States
(12) Patent Application Publication
(10) Pub. No.: US 2014/0099190 A1
(43) Pub. Date: Apr. 10, 2014

(54) GAS TURBINE ENGINE TURBINE HOUSING WITH ENLONGATED HOLES

(71) Applicant: SOLAR TURBINES INCORPORATED, San Diego, CA (US)

(72) Inventors: Christopher J. Meyer, San Diego, CA (US); Tsuhon Lin, San Diego, CA (US); Edward T. Ramirez, San Diego, CA (US)

(73) Assignee: SOLAR TURBINES INCORPORATED, San Diego, CA (US)

(21) Appl. No.: 13/646,526

(22) Filed: Oct. 5, 2012

(51) Int. Cl. F01D 25/14; B23P 6/00

(52) U.S. Cl. 415/116; 29/402.09; 29/402.06

(57) ABSTRACT

A turbine housing (430) includes a support housing (440) with an annular shape. The support housing (432) includes an outer surface (433) and an inner surface (434). The inner surface (434) is located radially inward from the outer surface (433). A plurality of cooling holes (431) extols through the support housing(440) from the outer surface (433) to the inner surface (434). The cooling holes (431) include a stadium shape. The stadium shape includes a rectangle with a top and bottom of a first length and ends capped with semicircles with a radius of a second length. The cooling holes (431) are disposed at an angle (98) from thirty to sixty degrees. The angle (98) is between a line (96) projected to the outer surface (433) from an axis of the turbine housing (430) and a line (97) extending through a center of each cooling hole (431) parallel to the first length.

### TECHNICAL FIELD

The present disclosure generally relates to gas turbine engine turbine housings and more particularly to a gas turbine engine turbine housing with cooling holes.

Gas turbine engines include-compressor, combustor, and turbine sections. Portions of a gas turbine engine are subject to high temperatures. In particular, the first stages of the turbine section are subject to such high temperatures that these stages are often cooled by directing relatively cool air through internal cooling passages.

U.S. Pat. No. 4,820,123, to K. Hall, describes a dirt removal means for air cooled blades of a gas turbine engine. The dirt removal means uses louvers stamped out of sheet metal that overlie the inlets of the blades' internal cooling passages. The louvers deflect dirt entrained in cooling air through a high velocity air stream and allow a cleaner portion of the cooling air to flow through the cooling passages of the blades.

The present disclosure is directed toward overcoming one or more of the problems discovered by the inventors.

### SUMMARY OF THE DISCLOSURE

A turbine housing includes a support housing with an annular shape. The support housing includes an outer surface and an inner surface. The inner surface is located radially inward from the outer surface. A plurality of cooling holes extends through the support housing from the outer surface to the inner surface. The cooling holes include a stadium shape. The stadium shape includes a rectangle with a top and bottom of a first length and ends capped with semicircles with a radius of a second length. The cooling holes are disposed at an angle from thirty to sixty degrees. The angle is between a line projected to the outer surface from an axis of the turbine housing and a line extending through a center of each cooling hole parallel to the first length.

A method for modifying a turbine housing with an annularly shaped first stage turbine support housing is also provided. The first stage turbine support housing includes a plurality of round cooling holes circumferentially overlapping with at least one opening to an airfoil cooling passage when the first-stage turbine nozzle support housing is assembled in a gas turbine engine. The method includes plugging the round cooling holes. The method also includes determining locations for new cooling holes. The new cooling holes cannot circumferentially overlap with the openings to airfoil cooling passages when the turbine housing is installed in a gas turbine engine. The method further includes machining new holes through the first stage turbine support housing.

### BRIEF DESCRIPTION OF THE DRAWINGS

FIG. 1 is a schematic illustration of an exemplary gas turbine engine.

FIG. 2 is a cross-sectional view of a portion of a gas turbine engine that includes a turbine housing.

FIG. 3 is a perspective view of a turbine housing according to an exemplary disclosed embodiment.

FIG. 4 is a side view of a portion of a turbine housing according to an exemplary disclosed embodiment.

FIG. 5 is a flowchart of a method for modifying a turbine housing.

### DETAILED DESCRIPTION

The systems and methods disclosed herein include cooling holes of a gas turbine engine turbine housing. In embodiments the cooling holes are elongated or stadium shaped and configured to provide cooling air to the gas turbine engine turbine nozzles. The cooling holes can be angled so as to not circumferentially overlap with the openings far the cooling air passages of the turbine nozzles when the turbine housing is installed in the gas turbine engine. This configuration can prevent large particles from entering the turbine nozzle cooling air passages. Large particles entering the turbine nozzle cooling air passages may clog or block the cooling air passages, inhibiting the cooling of the turbine nozzles.

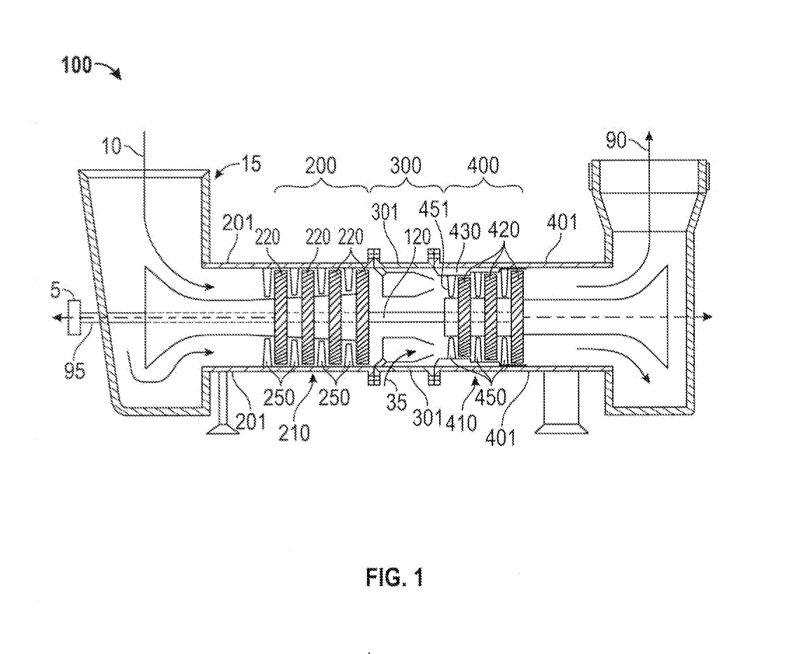

FIG. 1 is a schematic illustration of an exemplary gas turbine engine. A gas turbine engine 100 typically includes a compressor 200, a combustor 300, a turbine 400, and a shaft 120. The gas turbine engine 100 may have a single shaft or a dual shaft configuration. For convention in this disclosure all references to radial, axial, and circumferential directions and measures refer to center axis 95 unless otherwise specified. Center axis 95 may generally be defined by the longitudinal axis of shaft 120. Center axis 95 may be common to or shared with other gas turbine engine concentric components.

Air 10 enters an inlet 15 as a “working fluid” and is compressed by the compressor 200. Fuel 35 is added to the compressed air in the combustor 300 and then ignited to produce a high energy combustion gas. Energy is extracted from the combusted fuel/air mixture via the turbine 400 and is typically made usable via a power output coupling 5. The power output coupling 5 is shown as being on the forward side of the gas turbine engine 100, but in other configurations it may be provided at the aft end of gas turbine engine 100. Exhaust 90 may exit the system or be further processed (e.g., to reduce harmful emissions or to recover heat from the exhaust 90).

The compressor 200 includes a compressor rotor assembly 210 and compressor stationary vanes (“stators”) 250. The compressor rotor assembly 210 mechanically couples to shaft 120. As illustrated, the compressor rotor assembly 210 is an axial flow rotor assembly. The compressor rotor assembly 210 includes one of more compressor disk assemblies 220. Each compressor disk assembly 220 includes a compressor rotor disk that is circumferentially populated with compressor rotor blades. Stators 250 axially precede each of the compressor disk assemblies 220.

The turbine 400 includes a turbine rotor assembly 410, turbine nozzles 450, and a turbine housing 430. The turbine rotor assembly 410 mechanically couples to shaft 120. As illustrated, the turbine rotor assembly 410 is an axial flow rotor assembly. The turbine rotor assembly 410 includes one or more turbine disk assemblies 420. Each turbine disk assembly 420 includes a turbine rotor disk that is circumferentially populated with turbine rotor blades. Turbine nozzles 450 axially precede each of the turbine rotor assemblies 420. The turbine nozzles 450 have circumferentially distributed turbine nozzle vanes. The turbine nozzle vanes helically reorient the combustion gas that is delivered to the turbine rotor blades where the energy in the combustion gas is converted to mechanical energy and rotates the shaft 120.

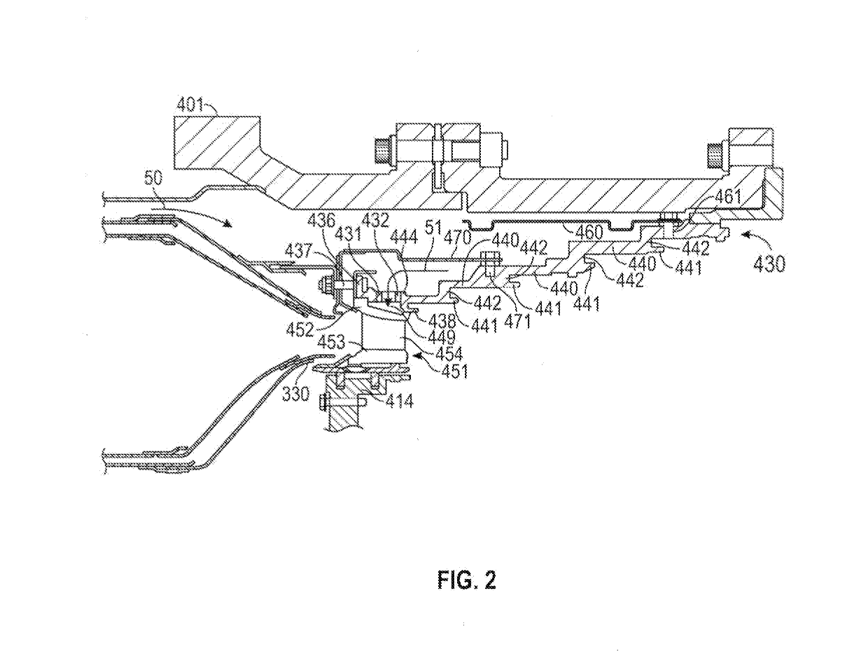

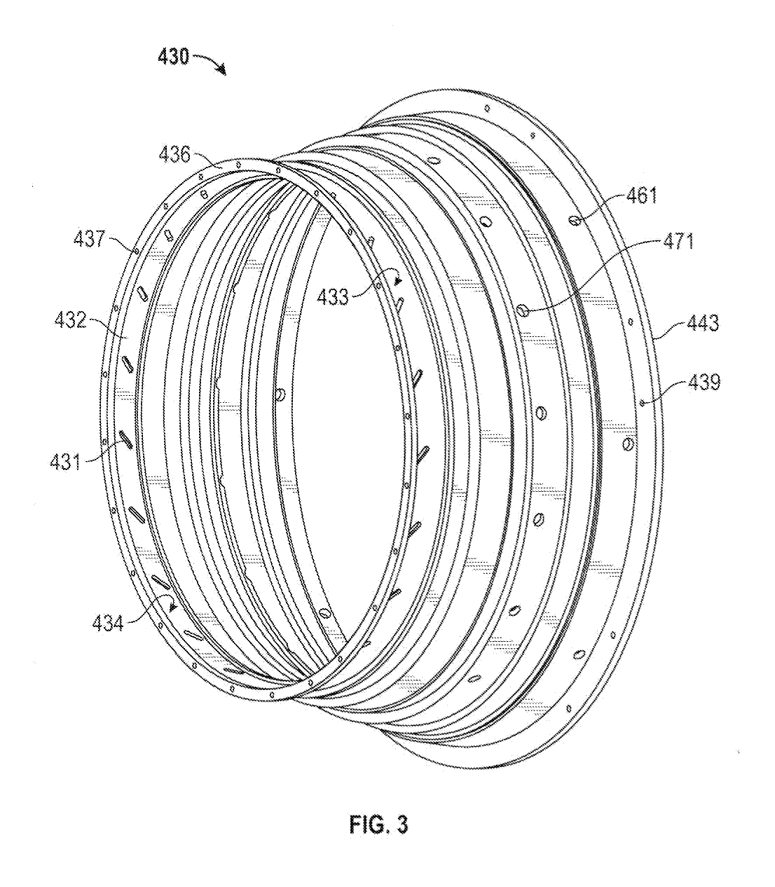

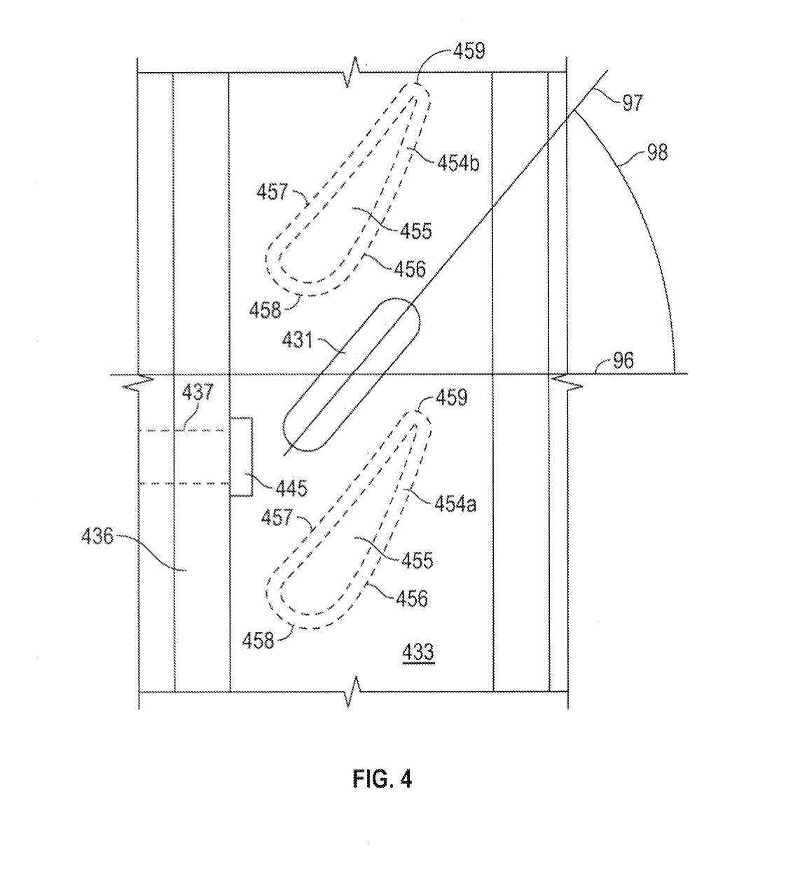

The turbine nozzles 450 may be coupled to turbine housing 430. The turbine nozzle 450 closest to the combustor 300 may be considered the first stage turbine nozzle 451. The turbine nozzles 450 may be cooled by routing cooling air from the compressor 200. The cooling air may be routed through cooling holes 431 (shown in FIG. 2, FIG. 3, and FIG. 4) in turbine housing 430 and into the turbine nozzle vanes of the turbine nozzles 450. In particular cooling air may be routed into the first stage turbine nozzle 451.

The various components of the compressor 200 are housed in a compressor case 201 that may be generally cylindrical. The various components of the combustor 300 and the turbine 400 are housed, respectively, in a combustor case 301 and a turbine case 401.

FIG. 2 is a cross-sectional view of a portion of a gas turbine engine that includes turbine housing 430. Turbine housing 430 depleted in FIG. 2 may be used in the gas turbine engine 100 of FIG. 1.

As can be seen in FIG. 2, turbine housing 430 may include support housings 440, transitions 442, hangers 441, first stage turbine nozzle support housing (“first stage housing”) 432, and forward flange 436. Each of these features may circumferentially extend completely around turbine housing 430. Each support housing 440 may be shaped generally as an annular band. Transitions 442 sit between each support housing 440. Transitions 442 extend either radially outward or radially inward from an aft end of a support housing 440 to a forward end of an axially aft adjacent support housing 440. Hangers 441 generally extend axially aft from an aft end of each support housing 440. Support housings 440 and hangers 441 generally support turbine components such as turbine nozzles and turbine shrouds. First stage housing 432 is the axially forward most support housing 440. First stage housing 432 may be shaped generally as an annular band.

FIG. 3 is a perspective view of turbine housing 430 according to an exemplary disclosed embodiment. Turbine housing 430 depicted in FIG. 3 may be used in the gas turbine engine 100 of FIG. 1. As can be seen in FIG. 3, first stage housing 432 may include outer surface 433, inner surface 434, and cooling holes 431. The circumferential exterior of first stage housing 432 may be defined by outer surface 433. The circumferential interior of first stage housing 432 may be defined by inner surface 434. Inner surface 434 is located radially inward from outer surface 433.

Turbine housing 430 is configured to include cooling holes 431 distributed circumferentially about first stage housing 432. Cooling holes 431 radially pass through first stage housing 432 from outer surface 433 to inner surface 434.

Forward flange 436 may protrude radially outward from an axially forward end of turbine housing 430. In one embodiment forward flange 436 protrudes from first stage housing 432. Forward flange 436 may include mounting holes 437. Mounting holes 437 are circumferentially located about flange 436. Each mounting hole 437 axis may be parallel to the axis of turbine housing 430. A coupler 445, such as a bolt, may be inserted into each mounting hole 437 to secure the turbine housing 430 to the gas turbine engine as shown in FIG. 2 and FIG. 4.

Referring now to FIG. 2, forward hanger 438, the forward most hanger 441, may generally extend axially aft with an L-shaped cross-section and may include a first section and a second section. The first section of forward hanger 438 may extend radially inward from an aft end of first stage housing 432. The second section of forward hanger 438 may extend axially aft from the first section.

First stage turbine nozzle (“nozzle”) 451 is located radially inward from first stage housing 432. Nozzle 451 includes an outer wall 452, an inner wall 453, and one or more airfoils 454. Inner wall 453 is adjacent to a diaphragm 414 and is located radially inward from outer wall 452. Outer wall 452 and inner wall 453 are connected by one or more airfoils 454. Outer wall 452 is located radial adjacent to first stage housing 432. First stage housing 432 and outer wall 452 may be configured to define cavity 449 there between. Cooling holes 431 are configured to be in flow communication with cavity 449. In one embodiment, cavity 449 is defined by first stage housing 432 and the outer wall 452 of multiple nozzles 451 and circumferentially extends completely around first stage housing 432.

FIG. 4 is a side view of a portion of turbine housing 430 according to an exemplary disclosed embodiment. Turbine housing 430 depicted in FIG. 4 may be used in the gas turbine engine 100 of FIG. 1. In the embodiment depicted in FIG. 2, FIG. 3, and FIG. 4 turbine housing 430 is a single integral piece. In alternative embodiments turbine housing 430 may be constructed from multiple pieces.

As can be seen in FIG. 4, airfoils 454 include a leading edge 458 and a trailing edge 459. A convex suction side 457 and a concave pressure side 458 extend between the leading edge 458 and the trailing edge 459. Airfoils 454 also include passages 455 for cooling air. Each passage 455 is in flow communication with the cavity 449 (shown in FIG. 2). In the embodiment shown in FIG. 4 each airfoil 454 includes one passage 455.

Cooling holes 431 are circumferentially offset or clocked relative to airfoils 454 and are configured to not overlap with a radially outward projection of the openings into passages 455. Each of the cooling holes 431 may supply cooling air to multiple, for example, two, of the airfoils 454. Referring to FIG. 4, cooling holes 431 may be located between paired together airfoils 454, wherein the cooling holes 431 may be situated between the pressure side 457 of a leading airfoil 454a and the suction side 456 of an adjacent trailing airfoil 454b. In the embodiment shown, cooling hole 431 is centered between the trailing edge 459 of the leading airfoil 454a and the leading edge 458 of the trailing airfoil 454b.

Cooling holes 431 are elongated holes. Cooling holes 431 may be of any elongated shape. The length of cooling holes 431 in an elongated direction may be more than three-quarters the axial length of the first stage housing 432. In one embodiment, cooling holes 431 are slots with a stadium shape, a rectangle with a top and bottom of a first length and ends capped with semicircles with a radius of a second length. In the depicted embodiment of FIG. 4 the first length is greater than the second length. The combined length of the first length along with the second length of each semicircle may be greater than three quarters of the first stage housing 432.

Each cooling hole 431 may be disposed at an angle 98. Angle 98 may be defined as the angle between line 96, a line projected to outer surface 433 from the axis of turbine housing 430, and line 97, a line extending through the center of cooling holes 431 in the elongated direction at outer surface 433. In one embodiment angle 98 is from thirty to sixty degrees so as to not overlap with a radially outward projection of passages 455. In the configuration shown, one cooling hole 431 provides cooling air to two airfoils 454.

The embodiments discussed above describe the first stage turbine nozzle support housing 432 being configured with cooling holes 431. However, any of support housings 440 may be configured with cooling holes 431 for providing a cooling path to the various stage nozzles of a gas turbine engine. Support housings 440 may also include an outer surface and an inner surface.

Referring again to FIG. 2, the turbine 400 may also include a radiation shield 460 and a particle deflector 470. The particle deflector 470 is positioned in axial alignment around turbine housing 430. In the embodiment of FIG. 2, the particle deflector 470 covers cooling holes 431.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Operating efficiency of a gas turbine engine generally increases with a higher combustion temperature. Thus, there is a trend in gas turbine engines to increase the temperatures. Gas reaching first stage turbine nozzles 451 from combustor outlet 330 may be 1000 degrees Fahrenheit or more.

To operate at such high temperatures, the first stage turbine nozzles 451 have internal cooling passages. A portion of the compressed air from the compressor 200 of the gas turbine engine is diverted from entering the combustor 300 and is routed to the internal cooling passages. The cooling air lowers the temperature of the first stage turbine nozzles 451 so as to deter corrosion, deformation, or melting. The internal cooling passages often include many small holes.

Particles can become entrained in the cooling air. The particles may be ingested by the gas turbine engine from its environment or self-generated within the gas turbine engine. The particles can accumulate in the internal cooling passages and interfere with cooling of turbine components such as the first stage turbine nozzles 451. The small holes in the internal cooling passages can clog and block the flow of cooling air in some areas. Accumulated particles can also cover surfaces in the internal cooling passages and form an insulating layer that reduces cooling effectiveness.

As shown in FIG. 2, an inlet cooling air flow 50 flows in a passage inside the turbine case 401. Nozzle cooling air flow 51 passes through turbine housing 430. Nozzle cooling air flow 51 travels through cooling holes 431 and into cavity 449. The cooling air may then enter passage 455, the internal cooling passages of the first stage turbine nozzles 451.

Cooling holes 431 may deter deterioration of the cooling of the first stage turbine nozzles 451 due to particle contamination. The configuration of cooling holes 431 relative to passages 455 of the first stage turbine nozzles 451 may create a torturous path for cooling air and any entrained particles. The torturous path may avoid accumulation of particles in passages 455. Cooling holes 431 may be circumferentially offset or clocked relative to the internal cooling passages 455. Without a direct path from cooling holes 431 into passages 455 the particles may be broken into smaller pieces that may pass through passages 455 without accumulating. Other particles may accumulate within cavity 449 rather than in passages 455. Still other particles may be deflected away from passages 455.

Some gas turbine engines have used a screen to shield the first stage turbine nozzles 451 from particles. However, the screens themselves are subject to clogging that can block the flow of cooling air to the nozzle and interfere with cooling. Furthermore, the screens are prone to deterioration that can contribute to the particles reaching the first stage turbine nozzles 451.

Other gas turbine engines, such as the one depicted in FIG. 2 may use a particle deflector 470 to create a torturous path for cooling air and any entrained particles. Cooling holes 431 may operate as a system with particle deflector 470 to prevent particles from entering into passages 455 within these gas turbine engines.

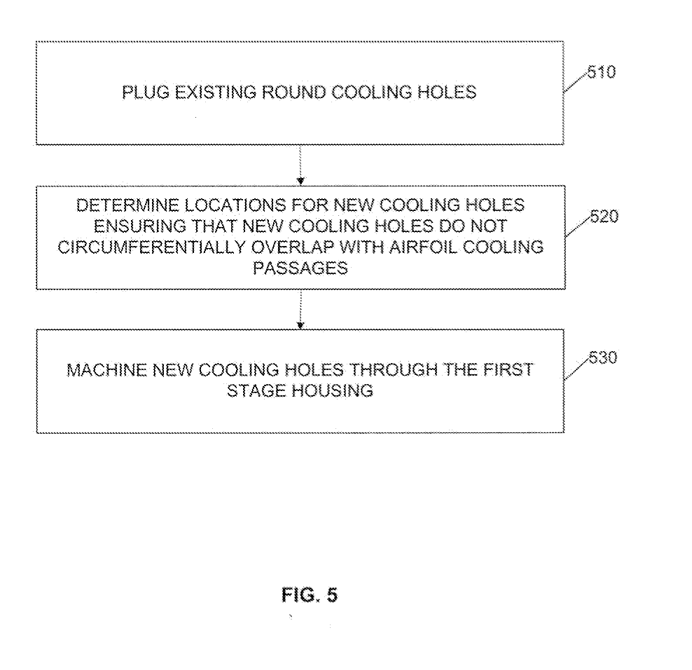

FIG. 5 is a flowchart of a method modifying turbine housing 430. Modifying turbine housing 430 includes plugging the existing round cooling holes at step 510. This may be done with a metal plug, such as a sheet metal plug. The plug may be welded to turbine housing 430. Turbine housing 430 may include round cooling holes that circumferentially overlap openings 456. This overlap gives a direct line of site into the internal cooling passages of airfoils 454. Cooling air with entrained dust particles may follow this non-torturous path through cooling holes 431 and openings 456 directly into the internal cooling passages of airfoils 454 resulting in the clogging of the internal cooling passages. This may lead to the problems discussed above.

Plugging the existing round cooling holes is followed by determining locations for new cooling holes at step 520. The locations are selected such that the new cooling holes do not circumferentially overlap passages 455 when turbine housing 430 is installed into a gas turbine engine. The new cooling holes may be cooling holes 431. Each cooling hole 431 may be centered between the trailing edge 459 of the leading airfoil 454a and the leading edge 458 of the trailing airfoil 454b as illustrated in FIG. 4.

At step 530, determining the location for new cooling holes is followed by machining the new cooling holes through first stage housing 432. Machining the new cooling holes may include machining a portion of the plug. Cooling holes 431 may have a stadium shape. The stadium shape may be easily machined and may reduce production costs.

The method of modifying turbine housing 430 may include removing an existing screen or particle deflector 470. In some embodiments the particle deflector 470 may be reinstalled. In other embodiments, a new particle deflector 470 is installed. The method may also include removing turbine housing 430 from a gas turbine engine prior to plugging the existing round cooling holes and reinstalling turbine housing 430 into a gas turbine engine after machining the new cooling holes.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes cooling holes, it will be appreciated that the cooling holes in accordance with this disclosure can be implemented in various other configurations and used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A turbine housing configured to provide a cooling path to airfoils of a gas turbine engine turbine nozzle, the airfoils including a suction side and a pressure side, the turbine housing comprising:
a support housing with an annular shape, the support housing having
an outer surface, and
an inner surface located radially inward from the outer surface,
wherein the outer surface and the Inner surface define the annular shape of the support housing; and
a plurality of cooling holes extending through the support housing from the outer surface to the inner surface, the cooling hole having
a stadium shape, the stadium shape including a rectangle with a top and bottom of a first length and ends capped with semicircles with a radius of a second length;
wherein the cooling holes are disposed at an angle from thirty to sixty degrees, the angle being between a line projected to the outer surface from the axis of the turbine housing and a line extending through a center of each cooling hole parallel to the first length.

2. The turbine housing of claim 1, wherein the cooling holes are configured to be circumferentially offset from the airfoils, and to not overlap with a radially outward projection of openings into internal cooling passages of the airfoils when the turbine housing is installed into a gas turbine engine.

3. The turbine housing of claim 1, wherein the cooling holes are elongated with the first length being greater than the second length.

4. The turbine housing of claim 1, wherein each cooling hole is configured to provide a flow of cooling air to a leading airfoil and a trailing airfoil.

5. The turbine housing of claim 3, wherein a length of the cooling holes in an elongated direction is greater than three-quarters the axial length of the support housing.

6. The turbine housing of claim 1, wherein each cooling hole is centered between a trailing edge of a leading airfoil and a leading edge of a trailing airfoil.

7. The turbine housing of claim 1, wherein the cooling holes are configured to provide a cooling path to airfoils of a first stage turbine nozzle when installed into a gas turbine engine.

8. The turbine housing of claim 1, further comprising:
a flange, wherein the flange extends radially outward from a forward end of the support housing, the flange having a plurality of mounting holes.

9. The turbine housing of claim 1, further comprising;
a forward hanger, wherein the forward hanger extends from an aft end the support housing, the forward hanger including
a first section extending radially inward from an aft end of the support housing, and
a second section extending axially alt from a radially inward end of the first section.

10. A turbine housing configured to provide a cooling path to airfoils of a gas turbine engine turbine nozzle, the turbine housing comprising:
a support housing with an annular shape, the support housing having
an outer surface, and
an inner surface located radially inward from the outer surface,
wherein the outer surface and the inner surface define the annular shape of the support housing; and
a plurality of cooling holes extending through the support housing from the outer surface to the inner surface, the cooling hole having
an elongated shape, with a first length being longer than a second length, the first length being more than three quarters the axial length of the support housing;
wherein the cooling holes are disposed at an angle from thirty to sixty degrees, the angle being between a line projected to the outer surface from the axis of the turbine
housing and a line extending through a center of each cooling hole parallel to the first length,

11. A gas turbine engine including the turbine housing of claim 10.

12. A gas turbine engine including the turbine housing of claim 10, further comprising:
a plurality of turbine nozzle assemblies, each turbine nozzle assembly having
an outer wall, the outer wall being located adjacent to the support housing and located radially inward from the support housing,
wherein the outer wall and the inner surface define a cavity for cooling air,
an inner wall, the inner wall being located radially inward from the outer wall, and
an airfoil connecting the inner wall to the outer wall, the airfoil including a suction side, a pressure side, and an opening for internal cooling passages;
wherein the cooling holes are located so as to be circumferentially offset from the airfoils and to not overlap with a radially outward projection of openings into internal cooling passages of the airfoils when the turbine housing is installed into the gas turbine engine.

13. A gas turbine engine including the turbine housing of claim 10, wherein each cooling hole is configured to provide a flow of cooling air to a leading airfoil and a trading airfoil.

14. A gas turbine engine including the turbine housing of claim 10, wherein each cooling hole is centered between a trailing edge of a leading airfoil and a leading edge of a trailing airfoil.

15. A gas turbine engine including the turbine housing of claim 10, further comprising a particle deflector circumferentially surrounding the support housing.

16. The turbine housing of claim 10, further comprising:
a flange, wherein the flange extends radially outward from a forward end of the support housing, the flange having a plurality of mounting holes,
a forward hanger, wherein the forward hanger extends from an aft end the support housing, the forward hanger including
a first section extending radially inward from an aft end of the support housing, and
a second section extending axially aft from a radially inward end of the first section.

17. A method for modifying a turbine housing, the turbine housing having a support housing with an annular shape, the support housing including a plurality of round cooling holes, wherein each round cooling hole circumferentially overlaps with at least one opening to an airfoil cooling passage when the support housing is assembled in a gas turbine engine, the method comprising:
plugging the round cooling holes;
determining locations for new cooling holes, such that the new cooling holes will not circumferentially overlap with the openings to airfoil cooling passages when the turbine housing is installed in a gas turbine engine; and
machining new holes through the support housing.

18. The method of claim 17, further comprising removing a screen used to shield the round cooling holes.

19. The method of claim 17, wherein a plug comprising sheet metal is used to plug the round cooling holes.

20. The method of claim 17, further comprising:
removing the turbine housing from a gas turbine engine prior to plugging the round cooling holes; and
reinstalling the turbine housing into the gas turbine engine after machining the new cooling holes through the first stage turbine support housing.
